(19) United States
(12) Patent Application Publication
(10) Pub. No.: US 2022/0386622 A1
(43) Pub. Date: Dec. 8, 2022

(54) BIOCONTROL COMPOSITION

(71) Applicant: Jorge Enrique Roldan Montoya, Bogota (CO)

(72) Inventor: Jorge Enrique Roldan Montoya, Bogota (CO)

(21) Appl. No.: 17/775,946

(22) PCT Filed: Nov. 23, 2020
(86) PCT No.: PCT/IB2020/061025

§ 371 Date: May 11, 2022

(30) Foreign Application Priority Data
Nov. 28, 2019 (CO) NC2019/0013425

(51) Int. Cl. A01N 63/20; A01N 63/22; A01N 63/23; A01N 63/30; A01N 61/00; A01N 43/90; A01N 63/32

(52) U.S. Cl. CPC A01N 63/20; A01N 63/22; A01N 63/23; A01N 63/30; A01N 61/00; A01N 43/90; A01N 63/32

(57) ABSTRACT

The present invention relates to a composition of effective biological control agents against eggs and/or larvae and/or pupae and/or adult insects' stages, with a broad-spectrum action. The invention is composed of sporulant entomopathogenic bacteria, entomopathogenic fungi, a limonoid, Efficient Microorganisms (EMs), a humic organic amendment in a liquid suspension, and a process for obtaining the composition.

### FIELD OF THE INVENTION

The present invention relates to a composition of effective biological control agents, against stages of eggs and/or larvae and/or pupae and/or adult insects, with a broad-spectrum action.

### BACKGROUND OF THE INVENTION

The stable fly (Stomoxys calcitrans L., Diptera: Muscidae) is one of the most important pest insects of livestock worldwide. Adults are hematophagous, females and males feed on the blood of cattle, horses, and other minor species; it causes different damages, including milk production losses, decreased reproductive efficiency, weight loss, and transmission of animal infectious diseases. Given the above, since its sting is painful, the animals lose blood, tranquility, and energy, and are predisposed to suffer other pathologies due to the transmission of Streptococcus spp. and Staphylococcus spp., among others.

A 25% of estimated losses are due to the biting action of the fly, this is because the animals decrease their food consumption which is reflected in the low milk yield and meat quality, low body-weights at weaning, and decreases in body-weight gain and food conversion.

The horn fly (Haematobia irritans) is a dipteran that parasitizes grazing bovines, feeding on blood, and developing larval and pupal stages in their feces. The adult size is about a half that of the housefly and, both sexes are hematophagous and remain constantly on the bovines which they leave only to lay the eggs on fresh feces. The horn fly prefers to feed on adult animals (mainly on dark coats) and within this category, the highest parasitic loads are observed in bulls, with populations that are common in these hosts exceeding 2,000 flies per animal. The feeding habits of the horn fly produce defensive manifestations of the cattle (such as, sudden and constant movements of the head and tail, kicks) causing stress, severe irritation, loss of energy, and the disruption of grazing that may cause decreased body-weight gain or the efficiency in feed conversion. Some bovines present allergic reactions to the fly's saliva and sometimes, itching and excessive scratching result in ulcers. The dermatitis produced also affects the quality of the hides, causing losses to the tannery industry.

The housefly (Musca domestica, Diptera: Muscidae) is one of the most common polluting insects in human settlements and has been associated as a vector of various foodborne pathogens. This pest insect reproduces on rotting plant matter or animal feces, where they acquire and transmit pathogens to feed/food, causing feed/food spoilage and disease transmission. In a conservative estimate, the housefly is associated with the vectorization of more than 100 etiological agents, including bacterial, protozoan, and viral ones. Among the various species of flies that harm livestock farms, the Musca domestica is considered a species that has a negative impact on livestock farms since they contaminate livestock products, transmit a variety of pathogens to animals and cause additional problems for producers by invading residential areas near livestock farms. Due to their feeding habits and their ability to move, flies favor the mechanical transport of pathogens responsible for typhoid fever, dysentery, mastitis, and keratoconjunctivitis in cattle. The form of transport of these, and many other pathogens, is carried out physically due to body villi, also located in the pads of the legs and inside its digestive system. Numerous research has determined that this species can transmit disease-causing organisms to both man and animals, including protozoa, bacteria, viruses, Rickettsia, and parasitic worms. In addition, epidemiological and entomological studies have shown that this species may play a role in the transmission of infectious agents that cause diarrhea, particularly shigellosis or dysentery.

Dermatobia hominis, is a fly of the Cuterebridae family, usually found from Northern Mexico to Northern Argentina. It is considered as one of the most important parasites of cattle. In Brazil, it is the second most important parasite in sheep farms after Cochliomya spp. These flies are primarily bovine parasites, but they can affect any warm-blooded animal. As the parasite grows (up to about 20 to 24 mm-long) and feeds on tissues, a furuncular lesion forms around it, often oozing pus. A single animal can have several hundred larvae that cause great discomfort and interfere with body-weight gain, milk yield, and cause the deterioration of hides quality.

Cochliomyia hominivorax (Diptera: Calliphoridae) is a fly whose larval stage causes severe parasitosis in warm-blooded domestic and wild animals, as well as in humans. This parasitic disease is serious because the fly larvae develop in the tissues of living animals, sometimes causing the death of the host. The cattle screwworm (CSW) is the common name given to any of the three larval instars of the Cochliomyia hominivorax fly, which, in its larval stage, is an obligate parasite of warm-blooded animals—including human, causing a clinical condition known as traumatic myiasis. At this point, it is necessary to define that a myiasis (Greek myia=fly; −iasis=suffix for the names of diseases) is the infestation of active or dead tissues of living vertebrate animals with larvae of various species of insects of the order Diptera, which they feed on healthy or necrotic tissues, fluids, or ingested food. Consequently, myiasis can be classified according to the site of infestation as skin tissues (by larvae of the subfamilies Cuterebrinae and Hipodermatinae and some species of the families Calliphoridae and Sarcophagidae) and body cavities (by larvae of the subfamily Gasterophilinae in the digestive tract) or classified according to the emphasis on their relationship with the host as obligatory, facultative, and accidental myiasis. It is thus clear that CSW causes an obligatory myiasis that is classified as traumatic because it develops in open wounds or natural body orifices.

Ticks are considered one of the most important livestock health-limiting factors in the tropics, affecting 80% of the world's bovine population. Specifically, Rhipicephalus microplus (formerly Boophilus microplus) is the one with the greatest economic impact in Mexico, Central America, South America, and Australia. Rhipicephalus microplus is the species with the highest incidence in the Caribbean biological corridor, mainly in Colombia and Venezuela. Ticks are important ectoparasites in public and animal health due to the transmission of various infectious agents and the development of serious diseases in their hosts. Tick infestations cause great economic losses not only due to the depreciation of the leather of infested animals, but also to the decrease in animal production since they are vectors of pathogenic agents and their management and control increase production costs.

Global economic losses due to ticks are estimated at US$7 billion, of which one billion dollars corresponds to Latin America (FAO, 2004) and to Colombia, calculating a bovine population of approximately 20 million heads, and a calculated loss of US$7.3 per head/year. The losses could be around US$146 million.

The control for both flies and ectoparasites has been based on the regular and indiscriminate use of synthetic molecules, which are applied by means of immersion and spray baths. This practice has been related to poor handling of chemical products, either due to under- or overdosing, rigorous product application mechanism, application frequency, selection and rotation of molecules, and lack of an epidemiological basis for the control of flies and ectoparasites. These have been the main causes for the emergence of resistance to most of the molecules used to control flies and ticks in cattle. In addition, the water contamination or residual in milk and meat.

As an alternative solution to chemical approaches, biological control of pests emerged, being biopesticides derived from natural materials such as animals, plants, microorganisms, and minerals, which are highly specific against target pests and generally represent little or no-risk to people or the environment, since they do not generate residual action and preserve ecosystem balance.

Biopesticides are generally divided into two large groups: microbial agents or pesticides—which include bacteria, fungi, viruses, and protozoa, and biochemical agents or pesticides—which include attractants, hormones, plant, and insect growth-regulators, enzymes and chemical signaling substances, very important in the plant-insect relationship. Most microbial insecticides are rapidly degraded after application, although some can reproduce under field conditions. The entomopathogenic microorganisms' group is varied and diverse. Among them are a wide group of viruses, bacteria, nematodes, and fungi, among others. Each of these subgroups is made up of several organisms that vary in the way they infect, the site of replication, and the pathogenic mechanism. While some pathogens have very wide host ranges, most prefer certain insect species. They also differ in their selective pathogenicity according to the different developmental stages of the insect host.

On the other hand, botanical pesticides derived from some parts or active ingredients of plants have been developed. In recent years, the application of various products obtained from plant extracts have drawn attention as effective and efficient alternatives to chemically synthesized insecticides. These compounds have been shown to affect insect populations, decreasing developmental survival and reproductive efficiency. Several plants that belong to different families contain a series of phytochemicals such as saponins, tannins, alkaloids, di- and triterpenoids, among others, with a high insecticidal activity. The harmful effect of plant extracts or their pure compounds against insects can be manifested in various ways, including toxicity, mortality, growth inhibition, suppression of reproductive behavior, and reduced fertility and fecundity.

Therefore, there is a need to develop bioinsecticide formulations that are effective in the management and control of a wide variety of insects without polluting the environment and that also promote the rapid degradation of polluting substrates that are produced on farms, agro-industrial companies, food plants, among other places, in which insects use residues as substrates to reproduce and grow, with the express objectives of maintaining adequate public health status and making productive activities sustainable.

The Efficient Microorganisms (EM) technology was developed by Dr. Teruo Higa, Ph.D, Professor of Horticulture at the University of the Ryukyus in Okinawa, Japan, in the 1960s. This is how biopesticides-related patent applications have also been filed, such as United States publication No. 2012/0039976, which describes the use of extracts from the pre-sporulation (preconidial) mycelial stage of entomopathogenic fungi as attractants and/or insect and arthropod pathogens.

United States Patent Application Publication No. 2010/0112060 describes insecticide compositions, comprising spores of entomopathogenic fungi suspended in oil-in-water emulsions, specifying the use of fatty acid salts, polyhydric alcohols, and additional emulsifiers. The publication further describes methods of using the compositions to prevent and control insect infestation in animals and natural areas; in particular, tick infestations are disclosed.

Published PCT patent application No. WO 11/099022, describes compositions and methods for preparing fungal products from an innovative combination of dormant spores of fungi Metarhizium anisopliae, Beauveria bassiana, and Verticillium lecanii, with enzymes, fats, and growth-promoter molecules. Uses for controlling pests such as aphids, whiteflies, mites, mealybugs, and caterpillars, as well as soil-borne insects such as white grubs, termites, and the like, are also disclosed.

Although there are many solutions to control a wide variety of pest insects, there is still a need to develop compositions and processes for obtaining bioproducts that not only control pest insects, but also degrade organic substrates where they can reproduce at high-speed action, then transform organic waste into organic materials available to be used in agricultural processes on farms and in other productive alternatives.

### DETAILED DESCRIPTION OF THE INVENTION

The object of the present invention is related to a biological control composition, effective against eggs and/or larvae and/or pupae and/or adult pest insects.

Where the composition is a mixture of one or more sporulant entomopathogenic bacteria, one more entomopathogenic fungi, a limonoid, EMs, and a humic organic amendment in a liquid suspension.

Where the sporulant entomopathogenic bacteria are selected separately or in combination with Bacillus popilliae and Bacillus thuringiensis.

Where the entomopathogenic fungi are selected separately or in combination with Beauveria bassiana, Lecanicillium lecanii, Metarhizium anisopliae, Paecilomyces lilacinus, and Paecilomyces fumosoroseus.

Where the EMs are selected separately or in combination with Rhodopseudomonas palustris, Lactobacillus spp., and Saccharomyces cerevisiae.

Where the humic organic amendment that is liquid in a concentrated and soluble suspension, is composed of organic compounds that comprise humic acid carbon (HAC) and fulvic acid carbon (FAC).

A limonoid, preferably selected as plant extract from neem or azadirachtin.

In a preferred embodiment of the invention, the composition comprises strains of Bacillus popilliae, Rhodopseudomonas palustris, Lactobacillus spp., Saccharomyces cerevisiae, Bacillus thuringiensis, Beauveria bassiana, Lecanicillium lecanii, Metarhizium anisopliae, Paecilomyces lilacinus, Paecilomyces fumosoroseus, organic compounds containing HAC and FAC, and azadirachtin.

The bioinsecticide composition makes it possible to control dipteran insects such as the stable fly (Stomoxys calcitrans L.), the horn fly (Haematobia irritans), the housefly (Musca domestica), the bot (Dermatobia hominis), the CSW (Cochliomyia hominivorax), and ticks (order: Ixodida—family: Ixodidade), among other insects.

The composition—in addition to having a bioinsecticide action, allows the degradation of organic waste and accelerates the decomposition processes, to convert waste into available organic matter, a fundamental element in areas of composting, management of residues from livestock activities and of crop-residues in various controlled or open-sky environments for agricultural use.

The invention is a bioinsecticide that exerts biological control and selective action. Intervenes on the insect's cuticle, and acts by contact and ingestion (causes septicemia). The biological control composition parasites the eggs and juvenile stages of the insect by biochemical action, through the secretion of hydrolytic enzymes such as proteases, chitinases, and lipases that digest the cell-wall of the insect. The biological control composition affects the egg, larvae, pupae, and insect in the adult stages. The biological control composition acts on each phase of the insect as follows:
Egg: It parasitizes postures with different strains, produces immunomodulatory substances or fungal toxins that affect the egg.
Larvae: Parasitizes the larval stage with different types of strains, produces immunomodulatory substances, hormonal blockade of the metamorphosis process of the larvae.
Pupae: Parasitizes the pupal stage; there is biochemical intervention with secretion of enzymes that digest the basement membrane and cover of the pupae, hormonal blockade of the insect metamorphosis process, which combined inhibits the growth of the insect.
Adult: It largely parasitizes insects that reach the adult stage; there is enzymatic and biochemical secretion that affects the basement membrane, the exoskeleton, the cuticle and various structures of the insect, inhibiting growth and reproduction. With the application of the product on the adult stage of the insect, a repellent action is also generated with one of its components.
   On the other hand, the biological control composition also degrades organic waste more quickly, transforming it into organic matter or composted waste, reducing the attractive material that the insect chooses as a substrate to develop.

The process of obtaining the composition of biological control and degradation of organic matter begins with the step of cleaning and chemical sterilization of the facilities, surfaces, utensils, and equipment to be used in the process. This to avoid any type of contamination or interference that affects the final product.

The selection and verification of raw-materials quality is carried out to have a final product with the efficacy for the recommended use.

According to the above, raw-materials must meet the following characteristics:

The active ingredients of the microorganism strains have a viable count of colonies (in Colony Form Units-CFU)/gram, as follows:

| | |
|---|---|
| Bacillus popilliae | Minimum 1 × 10⁵ CFU/gram |
| Bacillus thuringiensis | Minimum 1 × 10¹⁰ CFU/gram |
| Beauveria bassiana | Minimum 1 × 10¹² CFU/gram |
| Lecanicillium lecanii | Minimum 1 × 10¹² CFU/gram |
| Metarhizium anisopliae | Minimum 1 × 10¹² CFU/gram |
| Paecilomyces lilacinus | Minimum 1 × 10¹² CFU/gram |
| Paecilomyces fumosoroseus | Minimum 1 × 10¹⁰ CFU/gram |

The above microorganisms have a microbiological purity of minimum 90%, with a pH between 4.0 and 7.5 and a maximum humidity of 7%.

The following microorganisms are in a concentrated suspension with a purity percentage of at least 95%, pH between 3.2 and 3.6, a density of 1,002 g/mL and present a viable count of colonies (in CFU)/gram, as follows:

| | |
|---|---|
| Lactobacillus spp. | Minimum 1 × 10⁶ CFU/gram |
| Saccharomyces cerevisiae | Minimum 2 × 10⁴ CFU/gram |
| Rhodopseudomonas palustris | Minimum 2.5 × 10⁶ CFU/gram |

Liquid organic compounds are made up of HAC in a concentration between 85 and 90 g/L and FAC in a concentration between 10 and 13 g/L. This solution of organic compounds can have a mineral compound, specifically water-soluble potassium (K₂O) in a concentration of between 55 and 65 g/L.

The neem plant extract is Azadirachtin, found in a solution of between 0.1 and 10%, preferably between 0.2 and 0.8% and more preferably between 0.3 and 0.5%, with a density of 1,012 g/m L.

The biological control and organic matter degradation composition may have other elements such as colorants, sugar, and stabilizers.

Then, the weighing of raw materials is carried out, including the measurement of liquid inputs. Raw materials should be weighed or measured in the following order: Lactobacillus spp., Saccharomyces cerevisiae, Rhodopseudomonas palustris, Bacillus thuringiensis (previously homogenized), neem plant extract, liquid organic compounds in concentrated and soluble suspensions, Beauveria bassiana, Lecanicillium lecanii, Paecilomyces lilacinus, Paecelomyces fumosoroseus, Bacillus popilliae, Metarhizium anisopliae, and the other components.

The next step is the addition of raw materials and preparation of the mixture. In this step it must be considered that the entire weighed or measured quantity of the microorganisms Lactobacillus spp., Saccharomyces cerevisiae, and Rhodopseudomonas palustris is added, then Bacillus thuringiensis subsequently, and the stirrer is turned on and graduated to 300 revolutions per minute (RPM).

Subsequently, the process of gradual addition of the raw materials with microorganisms in powdered media begins: Bacillus popilliae, Beauveria bassiana, Lecanicillium lecanii, Paecilomyces lilacinus, Paecelomyces fumosoroseus, and Metarhizium anisopliae, between addition and addition of raw materials a mixture of 5 minutes to homogenize it. Next, the neem plant extract is added, and the mixture is left stirring for 3 minutes. Then the humic organic components in a liquid suspension are added entirely to the mixture being prepared, allowing stirring for 5 minutes. Finally, the other components are added; for example, the colorant, with gradual addition and allowing it to be incorporated into the mixture. It is recommended between addition and addition, to leave 4 minutes to increase the speed of the stirrer from 300 to 800 RPM to finish the incorporation of raw materials. Four minutes later, the speed is lowered from 800 to 300 RPM and the following gradual addition of raw materials is made. The process of increasing and decreasing the stirring speed must be repeated until the addition of raw materials is finished. The adding of all the raw materials to the mixture can take 80 to 90 minutes. When the addition process has been completed and the raw materials are mixed and incorporated, the speed of the mixer is increased to 1,400 RPM for 15 minutes to eliminate lumps, creams, and homogenize the mixture initial mix. In this step, the homogenization of the mixture must be guaranteed, for which a constant sampling is carried out; if lumps or creams are evidenced, it is stirred again at 1,400 RPM for 15 minutes, until the composition is homogeneous.

As a final step, the packaging of the product is carried out. In this step the product packaging containers must be prepared, which must be completely clean.

The packaging of the product is based on its density and is carried out by weight, a condition that requires in addition to the calculations of density and quantity of the product to be packed, knowing the previous grammage (weight) of the packaging containers. The product must be packed in containers according to the presentation (1 L, gallon/4 L, and gas can/20 L). In this step it is important to allow the product to degas (have high-quality packaging elements with a degassing valve), otherwise the container swells until it presents cracks and product leaks. Subsequently, the packaging is marked and labeled, where the following information contained in the product label must be included: —Manufacturer information (manufacturer's name—manufacturer's address—manufacturer's telephone numbers—optional manufacturer's security hologram stickers).

Product identification.

Product content.

Date of product formulation or manufacturing.

Product expiration date.

Product manufacturing batch.

Product general information.

Contents of the product per container.

Recommendations for use of the product.

Safety information for handling the product.

Toxicological category of the product.

Product handling pictograms.

### Example

The present example is a way of obtaining the composition for biological control and degradation of organic matter that comprises—as active ingredients, strains of microorganisms such as Bacillus popilliae, Rhodopseudomonas palustris, Lactobacillus spp., Saccharomyces cerevisiae, Bacillus thuringiensis, Beauveria bassiana, Lecanicillium lecanii, Metarhizium anisopliae, Paecilomyces lilacinus, and Paecilomyces fumosoroseus, as well as humic organic compounds and plant extracts obtained according to the following steps of the manufacturing process, which are an example of the best way to carry out the invention.

The manufacturing process of the composition of biological control and degradation of organic matter begins with the cleaning and chemical sterilization of the facilities, surfaces, utensils, and equipment that will be used in the process. In this step, the adjustment of the equipment is also carried out, that is, assemble the mixing disc of approximately 22 centimeters in diameter to the agitation equipment, place the mixing tank of the equipment in such a way that it is in the center of the mixer axis and verify that the discharge valve is closed. This to avoid any type of contamination or interference that affects the final product.

The second step is the selection and verification of the quality of the raw materials, to have a final product with the efficacy for the recommended use.

The third step is the weighing of raw materials, which includes the measurement of liquid inputs. It should be weighed or measured in the following order: Lactobacillus spp., Saccharomyces cerevisiae, Rhodopseudomonas palustris, Bacillus thuringiensis (previously homogenized), neem plant extract, liquid organic compounds in concentrated and soluble suspension, Beauveria bassiana, Lecanicillium lecanii, Paecilomyces lilacinus, Paecelomyces fumosoroseus, Bacillus popilliae, Metarhizium anisopliae, and the other components.

The percentages indicated in Table 1 are used for a production batch of the composition of 1000 L.

TABLE 1
Percentages of the biological control composition
and degradation of organic material.

| RAW MATERIAL | % OF EACH COMPONENT |
|---|---|
| Beauveria bassiana | 1.78 |
| Lecanicillium lecanii | 1.78 |
| Paecilomyces lilacinus | 1.78 |
| Paecelomyces fumosoroseus | 1.49 |
| Bacillus thuringiensis var. kurstaki | 1.78 |
| Metarhizium anisopliae | 1.78 |
| Bacillus popilliae | 0.19 |
| Lactobacillus spp., | |
| Saccharomyces cerevisiae, | 89.11 |
| Rhodopseudomonas | |
| palustris | |
| Humic organic amendment | 0.12 |
| in a liquid suspension | |
| Neem plant extract | 0.09 |
| Colorant | 0.10 |

The fourth step is the addition of raw materials and preparation of the mixture. In this step it must be considered that the entire weighed or measured quantity of the microorganisms Lactobacillus spp., Saccharomyces cerevisiae, Rhodopseudomonas palustris is added, then Bacillus thuringiensis is added later, the stirrer is turned on and set at 300 RPM. Subsequently, the process of gradual addition of the raw materials with microorganisms in powdered media begins: Bacillus popilliae, Beauveria bassiana, Lecanicillium lecanii, Paecilomyces lilacinus, Paecelomyces fumosoroseus, and Metarhizium anisopliae; between addition and addition of raw materials a mixture of 5 minutes to homogenize the mixture. Next, the neem plant extract is added, and the mixture is left stirring for 3 minutes. Then the humic organic amendment in a liquid suspension is added in its entirety to the mixture being prepared, allowing stirring for a period of 5 minutes. Finally, the other components are added; for example, the colorant, with gradual addition and allowing it to be incorporated into the mixture. It is recommended between addition and addition to consider 5 minutes in which the speed of the revolutions of the stirrer is raised from 300 to 800 RPM to finish incorporating the raw materials. After 4 minutes, the speed is lowered from 800 to 300 RPM and the following gradual addition of raw materials. The process of increasing and decreasing the stirring speed should be repeated until the addition of raw materials is complete. When the addition process has been completed and the raw materials are mixed and incorporated, the speed of the mixer is increased to 1,400 RPM for 15 minutes, to eliminate lumps, creams, and homogenize the mixture initial mix. In this step, the homogenization of the mixture must be guaranteed, for which a constant sampling is carried out.

A process for obtaining the biological control composition can be defined, comprising the following steps, in the same order:

a. Add EMs;
b. Add sporulant entomopathogenic bacteria;
c. Shake for 200 to 400 RPM, for 3 to 10 minutes;
d. Add entomopathogenic fungi;
e. Shake for 3 to 10 minutes;
f. Add the limonoid;
g. Shake for 3 to 5 minutes;
h. Add the humic organic amendment in a liquid suspension;
i. Shake for 3 to 10 minutes;
j. Increase stirring speed from 1200 to 1600 RPM;
k. Shake for 10 to 20 minutes;
l. Obtain the biological control composition.

The previous stages are produced under conditions of pressure less than 1 atmosphere and a temperature between 10 and 50° C.

The process for obtaining the biological control composition, where in steps e), g), i), the stirring speed is increased from 700 to 900 RPM, preferably 800 RPM, the stirring speed is again lowered from 200 to 400 RPM, preferably 300 RPM.

The fifth step is the packaging of the product. In this step, the product packaging containers must be prepared, which must be completely clean. The packaging of the product is based on the density of its density and is carried out by weight, a condition that requires—in addition to the calculations of density and quantity of the product to be packed, knowing the previous grammage (weight) of the packaging containers. The product must be packed in containers according to the presentation (1 L, gallon/4 L, and gas can/20 L). In this step it is important to allow the product to degas (have high-quality packaging elements with a degassing valve), otherwise the container swells until it presents cracks and product leaks. Subsequently, the packaging is marked and labeled.

The product obtained from the previous manufacturing process is a biological control composition and degradation of organic matter that includes, as active ingredients, strains of microorganisms such as Bacillus popilliae, Rhodopseudomonas palustris, Lactobacillus spp., Saccharomyces cerevisiae, Bacillus thuringiensis, Beauveria bassiana, Lecanicillium lecanii, Metarhizium anisopliae, Paecilomyces lilacinus, and Paecilomyces fumosoroseus, as well as liquid organic compounds and plant extracts, with the appearance of a soluble concentrate, grass-green viscous liquid, with a density between 1.03 and 1.04 g/mL, a pH between 3.5 and 3.6, and a water-solubility of 100%.

The biological control composition and degradation of organic matter in its contents, has been widely tested in the management and control of the dipteran insect known as stable fly (Stomoxys calcitrans L.), showing high efficacy in controlling insect populations. It has had evaluations in the control of other types of insects with highly favorable results and in the management and degradation of organic substrates with a high speed of beneficial action.

The previous description can only be taken as a reference and not limiting its components or their explicit relationship, but rather they have been described to provide a clear idea about the general conformation of the subject matter of the claimed invention.

1. Biological control composition comprising: sporulant entomopathogenic bacteria, entomopathogenic fungi, a limonoid, Efficient Microorganisms (EMs), and a humic organic amendment in a liquid suspension.

2. The biological control composition according to claim 1, wherein the sporulant entomopathogenic bacteria comprises at least one of Bacillus popilliae or Bacillus thuringiensis.

3. The biological control composition according to claim 1, wherein the entomopathogenic fungi comprises at least one of Beauveria bassiana, Lecanicillium lecanii, Metarhizium anisopliae, Paecilomyces lilacinus, or Paecilomyces fumosoroseus.

4. The biological control composition according to claim 1, wherein the humic organic amendment in a liquid suspension comprises humic acid carbon (HAC) and fulvic acid carbon (FAC) compounds.

5. The biological control composition according to claim 1, wherein the EMs comprises at least one of Rhodopseudomonas palustris, Lactobacillus spp., or Saccharomyces cerevisiae.

6. The biological control composition according to claim 1, wherein the limonoid is a plant extract of neem or Azadirachtin.

7. The biological control composition according to claim 2, wherein the sporulant entomopathogenic bacteria have a viable count of colonies as follows:

| | |
|---|---|
| Bacillus popilliae | Minimum 1 × 10⁵ CFU/gram |
| Bacillus thuringiensis | Minimum 1 × 10¹⁰ CFU/gram. |

8. The biological control composition according to claim 3, wherein the sporulating entomopathogenic bacteria have a viable count of colonies as follows:

| | |
|---|---|
| Beauveria bassiana | Minimum 1 × 10¹² CFU/gram |
| Lecanicillium lecanii | Minimum 1 × 10¹² CFU/gram |
| Metarhizium anisopliae | Minimum 1 × 10¹² CFU/gram |
| Paecilomyces lilacinus | Minimum 1 × 10¹² CFU/gram |
| Paecilomyces fumosoroseus | Minimum 1 × 10¹⁰ CFU/gram. |

9. The biological control composition according to claim 4, wherein the HAC compounds have a concentration between 85 and 90 g/L and the FAC compounds have a concentration between and to 13 g/L.

10. The biological control composition according to claim 9, wherein the humic organic amendment in a liquid suspension further comprises a mineral compound in a concentration between 55 and 65 g/L.

11. The biological control composition according to claim 5, wherein EMs have a viable count of colonies as follows:

| | |
|---|---|
| Rhodopseudomonas palustres | Minimum 2.5 × 10⁶ CFU/gram |
| Lactobacillus spp. | Minimum 1 × 10⁶ CFU/gram |
| Saccharomyces cerevisiae | Minimum 2 × 10⁴ CFU/gram. |

12. The biological control composition according to claim 6, where the Azadirachtin is in a solution between 0.1 and 10%, with a density of 1.012 g/mL.

13. A process for obtaining a biological control composition comprising the following steps in the following order:
a. combining Efficient Microorganisms (EMs) and sporulant entomopathogenic bacteria;
b. stirring said combination for 3 to 10 minutes;
c. adding entomopathogenic fungi to the combination;
d. stirring said combination for 3 to 10 minutes;
e. adding limonoid to the combination;
f. stirring said combination for 3 to 5 minutes;
g. adding humic organic amendment in a liquid suspension to the combination;
h. stirring said combination for 3 to 10 minutes;
i. increasing a stirring speed to 1200 to 1600 RPM; and
j. stirring said combination for 10 to 20 minutes;
wherein the process is carried out under conditions of pressure less than 1 atmosphere and a temperature between 10 and 50° C. to obtain the biological control composition.

14. The process for obtaining a biological control composition according to claim 13, wherein the stirring speed in steps d), f), h) is increased to 700 to 900 RPM and decreased to 200 to 400 RPM at an end of the stirring step.

15. The process for obtaining a biological control composition, according to claim 13, wherein the stirring speed in steps d), f), h) is increased to 800 RPM and decreased to 300 RPM at an end of the stirring step.

16. The process for obtaining a biological control composition, according to claim 13, wherein the stirring speed in step b) is 200 to 400 RPM.

17. The process for obtaining a biological control composition, according to claim 13, wherein the stirring speed in step b) is 300 RPM.

18. The process for obtaining a biological control composition, according to claim 13, wherein the stirring speed in step i) is increased to 1400 RPM.

19. The biological control composition according to claim 10, wherein the mineral compound is water-soluble potassium (K₂O).
